(19) United States
(12) Patent Application Publication
(10) Pub. No.: US 2018/0233304 A1
(43) Pub. Date: Aug. 16, 2018

(54) BUTTON UNIT AND ELECTRONIC DEVICE

(71) Applicant: SONY CORPORATION, TOKYO (JP)

(72) Inventor: ISAO TAKAHASHI, SAITAMA (JP)

(73) Assignee: Sony Corporation, Tokyo (JP)

(21) Appl. No.: 15/751,294

(22) PCT Filed: Jul. 19, 2016
(86) PCT No.: PCT/JP2016/071129

§ 371 Date: Feb. 8, 2018

(30) Foreign Application Priority Data
Sep. 1, 2015 (JP) 2015-171842

(51) Int. Cl. H01H 13/14; H01H 13/64; H01H 13/807

(52) U.S. Cl. CPC H01H 13/14; H01H 13/807; H01H 13/64

(57) ABSTRACT

[Object] To propose a new and improved button unit and electronic device, in which an attitude of a button of an electronic device can be made stabilize. [Solution] A button unit including: an operating member that presses a member to be pressed, in response to being press operated; and an urging member that urges the operating member against the member to be pressed. In this way, there can be provided the new and improved button unit and electronic device, in which the attitude of a button of an electronic device can be made stabilize

### TECHNICAL FIELD

The present disclosure relates to a button unit and an electronic device.

### BACKGROUND ART

One known operation button of a conventional electronic device is such that a button part having a predetermined button is fitted in from a body case, and the button is made to protrude slightly from the body case, as described in Patent Literature 1, for example.

### CITATION LIST

### Patent Literature

Patent Literature 1: JP 2006-4710A

### DISCLOSURE OF INVENTION

### Technical Problem

However, typically in the manufacture and assembly of a parts of buttons, error, albeit slight, may occur for a variety of reasons. Therefore, usually, in a state in which the button is not being pressed, there ends up being a slight gap between the button and a switch to be pressed by the button. If there is such a gap, a situation may occur in which the attitude of the button with respect to the body case is not fixed. Also, as a result, there may be a slight change in the external appearance of the electronic device, or there may be variation in the stroke and feel when pressing the button.

Therefore, the present disclosure proposes a new and improved button unit and electronic device, in which the attitude of a button of an electronic device can be made stabilize.

### Solution to Problem

According to the present disclosure, there is provided a button unit including: an operating member that presses a member to be pressed, in response to being press operated; and an urging member that urges the operating member against the member to be pressed.

### Advantageous Effects of Invention

As described above, the present disclosure proposes a new and improved button and electronic device, in which the attitude of a button of an electronic device can be made stabilize.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a schematic perspective view of an electronic device according to an embodiment of the present disclosure.

FIG. 2 is a sectional view taken along line x-x of the electronic device illustrated in FIG. 1.

FIG. 3 is an exploded perspective view of the electronic device illustrated in FIG. 1.

FIG. 4 is an exploded perspective view of a button unit included in the electronic device illustrated in FIG. 1.

FIG. 5 is an exploded perspective view of a button unit included in the electronic device illustrated in FIG. 1.

FIG. 6 is a perspective view of an urging member illustrated in FIG. 5.

FIG. 7 is a perspective view illustrating the urging member illustrated in FIG. 5 in a state adhered to a button panel part.

FIG. 8 is a perspective view of the urging member illustrated in FIG. 5 in a state connected to a mounting member.

FIG. 9 is a perspective view of a pusher plate illustrated in FIG. 5 as viewed from a switch substrate side.

FIG. 10 is a perspective view of the pusher plate illustrated in FIG. 5 in a mounted state.

FIG. 11 is a perspective view of an operating member illustrated in FIG. 4 as viewed from the mounting member side.

FIG. 12 is a perspective view of a mounting plate to which a mounting member illustrated in FIG. 5 is connected.

FIG. 13 is a plane view of a mounting plate to which the mounting member illustrated in FIG. 5 is connected.

FIG. 14 is a partial enlarged view of a mounting plate 310 illustrated in FIG. 13.

FIG. 15 is a partial enlarged sectional view illustrating the connection state of the mounting member and the operating member of the button unit illustrated in FIG. 2.

FIG. 16 is a partial enlarged sectional view of the electronic device illustrated in FIG. 2.

FIG. 17 is a schematic sectional view of a switch device according to related art.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, in the present specification and drawings, similar structural elements of different embodiments will be distinguished by adding a different letter of the alphabet after the same reference numeral. However, in cases where there is no particular need to distinguish among each of a plurality of structural elements having substantially the same functional configuration, only the same reference numeral will be used. Note that members that do not need to be described are omitted, as appropriate, from the drawings in order to simplify the description. Also, the dimensions of each member in the drawings are enlarged or reduced, as appropriate, to simplify the description and do not indicate the actual size of each member.

Note that the description will be given in the following order.

1. Outline of electronic device

2. Components of button unit

2.1. Components of operating member

2.2. Components of mounting member

2.3. Components of abutting portion

3. Other components of electronic device

4. Summary

5. Modified examples

### 1. Outline of Electronic Device

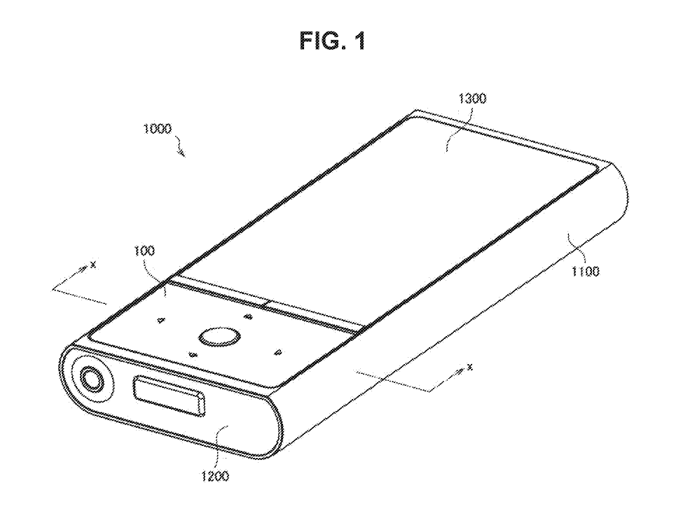

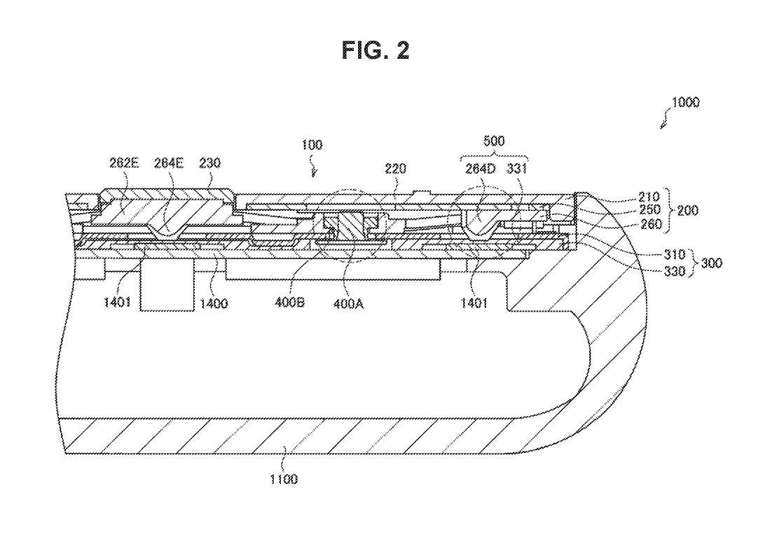

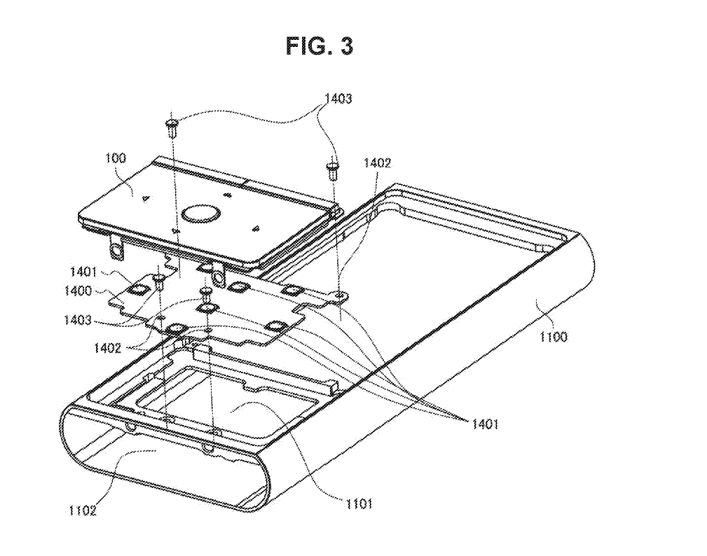

First, the schematic configuration of an electronic device according to an embodiment of the present disclosure will be described with reference to FIG. 1 to FIG. 3. FIG. 1 is a schematic perspective view of an electronic device (portable media player) 1000 according to an embodiment of the present disclosure. FIG. 2 is a sectional view taken along line x-x of the electronic device 1000 illustrated in FIG. 1. FIG. 3 is an exploded perspective view of the electronic device 1000 illustrated in FIG. 1.

The portable media player 1000 illustrated in FIG. 1 is one example of an electronic device. The portable media player 1000 includes a case 1100, a lid 1200, a display 1300, a switch substrate 1400, and a button unit 100.

Also, as illustrated in FIG. 2 and FIG. 3, the switch substrate 1400 and the button unit 100 that is disposed to the outside of the switch substrate 1400 are arranged in an opening 1101 disposed on the display-side principal surface of the case 1100. Also, a tactile switch 1401 on the switch substrate 1400 is pressed by a user appropriately pressing each part of the button unit 100, and in turn operates, such that each element within the portable media player 1000 operates. Therefore, the portable media player 1000 is configured to be able to be operated by the user.

Hereinafter, first, mainly the components of the button unit 100 and the relationship between the button unit 100 and the switch substrate 1400 will be described, and then the other components of the portable media player 1000 will be described.

### 2. Components of Button Unit

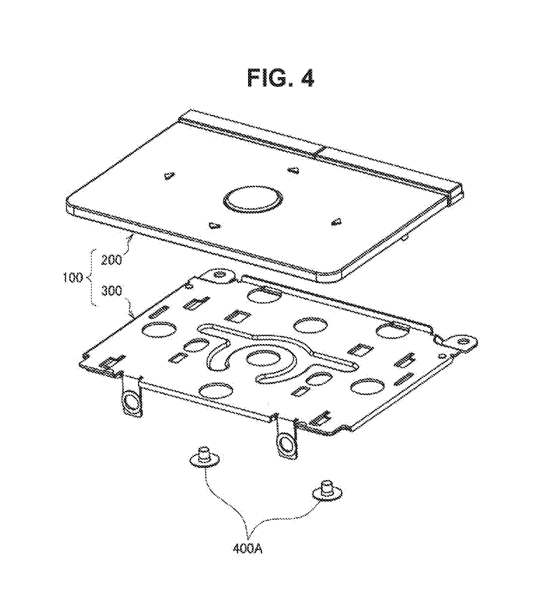

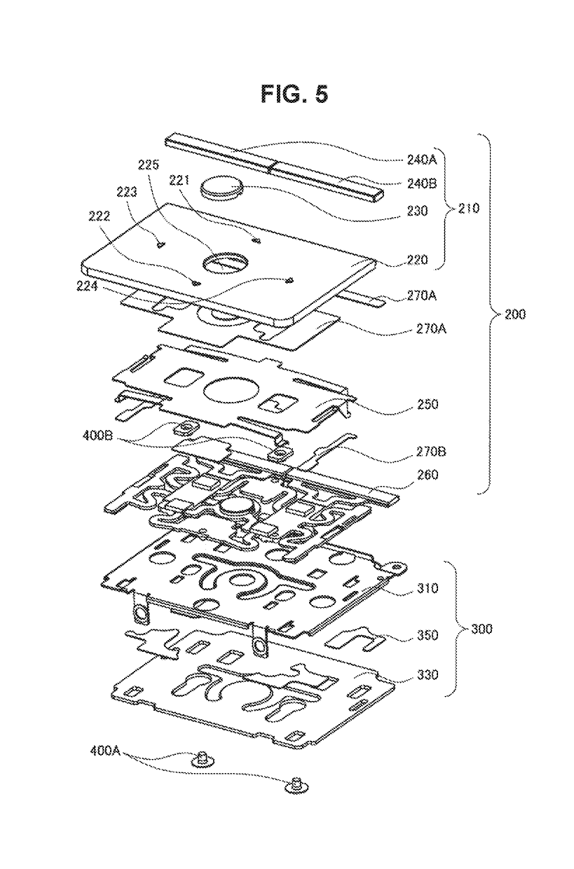

FIG. 4 and FIG. 5 are each an exploded perspective view of the button unit 100 included in the electronic device 1000 illustrated in FIG. 1. As illustrated in FIG. 4, the button unit 100 has an operating member 200, and a mounting member 300 for mounting the operating member 200 to the case 1100 (the portable media display 1000).

[2.1 Components of Operating Member]

The operating member 200 is an operating panel provided for a user to operate the portable media player 1000. The operating member 200 is configured such that, when a user presses a predetermined part of the operating member 200, the pressed force is transmitted to the tactile switch 1401 on the switch substrate 1400. The operating member 200 has a button panel portion 210, an urging member 250, a pusher plate 260, and adhesive material 270A and 270B that fixes these members together. Note that in the present embodiment, the urging member 250 is included in and integrated with the operating member 200.

(Panel Portion)

As illustrated in FIG. 5, the button panel portion 210 includes a four-direction button 220, a center button 230, and long buttons 240A and 240B.

The four-direction button 220 is one example of a directional key (directional pad). The four-direction button 220 is a flat plate having a generally rectangular overall shape. Also, the four-direction button 220 is arranged such that the long side is orthogonal to the long side of the portable media player 1000. The four-direction button 220 is arranged with an up direction pressing area 221, a down direction pressing area 222, a left direction pressing area 223, and a right direction pressing area 224, when the display 1300 side is up. When a user presses these areas 221 to 224, the corresponding tactile switch 1401 is consequently pressed via an abutting portion that will be described later. Also, the four-direction button 220 has a circular through-hole 225 that corresponds to the shape of the center button 230, near the center.

The center button 230 is a disc-like button arranged in the through-hole 225 of the four-direction button 220. Also, the long buttons 240A and 240B are arranged with the longitudinal direction of each along a display-side end portion of the four-direction button 220. When a user presses the center button 230 and the long buttons 240A and 240B as well, the corresponding tactile switch 1401 is consequently pressed via an abutting portion that will be described later.

Note that the four-direction button 220, the center button 230, and the long buttons 240A and 240B are not particularly limited, but the operation surface includes hard material. With such an operation surface that includes hard material, attitude inclination in response to pressure typically tends to be greater than with an operation surface of soft material. Therefore, with an operation surface that includes hard material, the stroke and feel when pressing the operation surface typically tend to change. However, because the button panel portion 210 of the button unit 100 is urged by the urging member 250, such a tendency is mitigated. As a result, even in a case where the button panel portion 210 includes hard material, the stroke and feel during a pressing operation are uniform. Examples of such hard material include relatively hard resin material such as thermosetting resin, and metal material such as aluminum, titanium, iron, and copper, and an alloy of stainless steel and the like. For example, the four-direction button 220 can also be selected according to the material of the case 1100, and can be metal material.

Further, the four-direction button 220 is fixed to the urging member 250 via the adhesive material 270A, and the center button 230 and the long buttons 240A and 240B are fixed to the pusher plate 260 via the adhesive material 270A. Note that adhesive paper, for example, can be used as the adhesive material 270A. The same applies to the adhesive material 270B that will be described later.

(Urging Member)

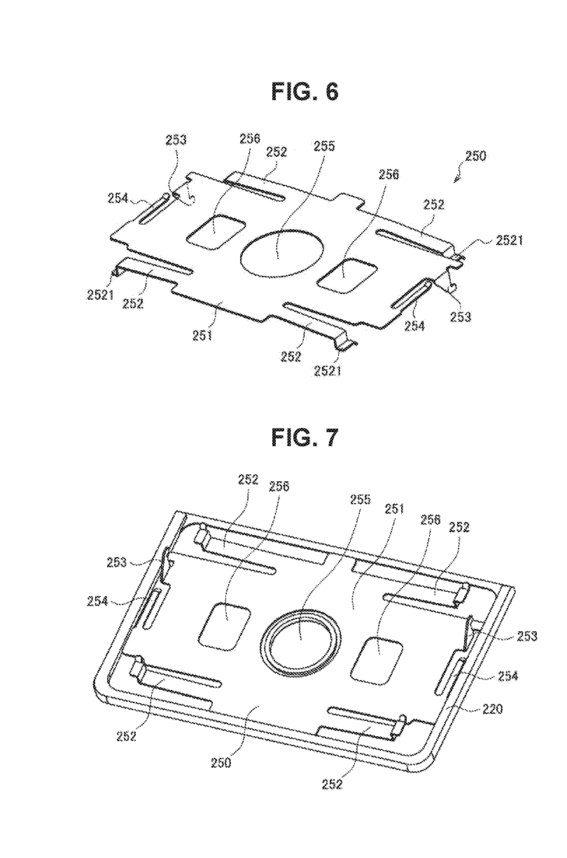

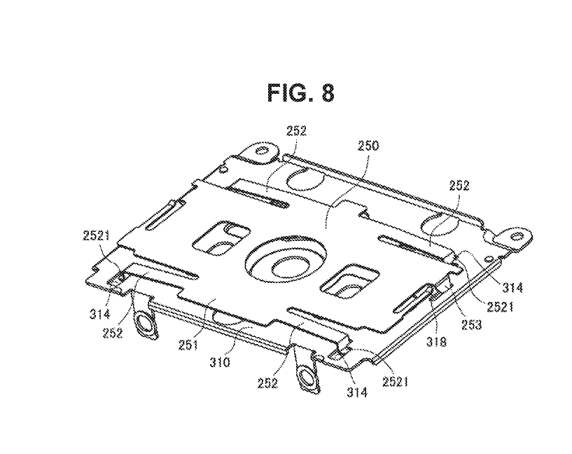

FIG. 6 is a perspective view of the urging member 250 illustrated in FIG. 5, FIG. 7 is a perspective view of urging member 250 illustrated in FIG. 5 in a state adhered to the button panel portion 210, and FIG. 8 is a perspective view of the urging member 250 illustrated in FIG. 5 in a state connected to the mounting member 300.

The urging member 250 illustrated in FIG. 6 has a plate shape overall. Also, the urging member 250 has a shape corresponding to the principal surface of the four-direction button 220 described above. As illustrated in FIG. 7, the urging member 250 is fixed to the principal surface of the device side of the four-direction button 220 in such a manner that the longitudinal direction of the urging member 250 matches the longitudinal direction of the four-direction button 220.

The urging member 250 has a flat plate portion 251, a leaf spring 252, a detachment controlling member 253, a conducting portion 254, and holes 255 and 256 formed in the flat plate portion 251.

The flat plate portion 251 is a flat plate that forms the basic shape of the urging member 250. The flat plate portion 251 urges the button panel portion 210 and the pusher plate 260 of the flat plate portion 251 to the mounting member 300 side. Note that such urging using the flat plate portion 251 enables the force applied to the button panel portion 210 and the pusher plate 260 that are urged to be made uniform between each part.

The leaf spring 252 is one example of an elastic portion. The leaf spring 252 is formed at the four corners of the flat plate portion 251, i.e., a total of four leaf springs 252 are formed, one at each end portion in the longitudinal direction and the width direction. The leaf spring 252 is formed by a portion of the flat plate portion 251 being cut long and narrow along the longitudinal direction of the urging member 250. A tip end 2521 of the leaf spring 252 is folded as appropriate. As illustrated in FIG. 8, the tip end 2521 of the leaf spring 252 is able to engage with an engaging hole 314 in a mounting plate 310 of the mounting member 300 that will be described later. As a result, elastic force from the leaf spring 252 acts to pull the urging member 250 and the mounting member 300 closer together, such that the flat plate portion 251 can urge the pusher plate 260 and the four-direction button 220 toward the mounting member 300 side. Moreover, because the center button 230 and the long buttons 240A and 240B described above are fixed to the pusher plate 260, these buttons are also urged simultaneously toward the mounting member 300 side. Therefore, the entire operating member 200 is urged toward the mounting member 300 side, and thus toward the tactile switch 1401 of the switch substrate 1400 of the portable media player 1000, by the flat plate portion 251.

In this way, the arrangement position and inclination of the operating member 200 can be prevented from becoming unstable, by the operating member 200 being urged toward the tactile switch 1401 side. That is, the attitude of the operating member 200 is stabilized. As a result, the operating member 200 is always arranged in a predetermined position in the case 1100, so the stroke and feel of a pressing operation of the operating member 200 of the portable media player 1000 are able to be made uniform. Also, by employing a configuration in which urging is performed in advance by the urging member 250 in this way, it is also possible make the stroke and feel of a pressing operation among products uniform in a case where a plurality of the portable media players 1000 are manufactured. Further, by stabilizing the attitude of the operating member 200, the button panel portion 210 that is arranged on the outer surface of the operating member 200 can be in a desired position in the case 1100. As a result, the external appearance of the portable media player 1000 within which the button unit 100 is arranged is able to be excellent.

Note that in a case where the button unit 100 is viewed from above, the leaf spring 252 is arranged in a position where pushers 264B to 264E of the pusher plate 260, and thus the abutting portion that will be described later, are not arranged. Therefore, the force that acts on each of the pushers 264B to 264E is made uniform, so the positions of the pushers 264B to 264E in a direction orthogonal to the principal surface of the mounting member 300 are more likely to be uniform. Moreover, because the four leaf springs 252 are arranged at the four corners of the flat plate portion 251, the force that acts on the flat plate portion 251 is able to be made uniform, and as a result, the attitude of the operating member 200 is more stable along the surface of the case 1100.

The detachment controlling member 253 illustrated in FIG. 6 is formed on a longitudinal end portion of the flat plate portion 251. The detachment controlling member 253 is formed by a portion of plate material of the flat plate portion 251 being bent toward the mounting member 300. Also, as illustrated in FIG. 8, a tip end of the detachment controlling member 253 is configured to be able to engage with a detachment controlling hole 318 in the mounting plate 310 of the mounting member 300 that will be described later. Therefore, the detachment controlling member 253 prevents the flat plate portion 251 and the entire operating member 200 that is connected to the flat plate portion 251 from unintentionally detaching from the mounting member 300. The detachment controlling member 253 also prevents each member of the operating member 200, such as the pusher plate 260, from being damaged.

The conducting portion 254 is formed adjacent to the detachment controlling member 253, on a longitudinal end portion of the flat plate portion 251. The conducting portion 254 includes material having conductivity, and is able to cause the urging member 250 to be connected to a reference potential point by contacting another conductive member inside the portable media player 1000.

Also, a hole 255 corresponding to the shape of the center button 230 is formed in the center portion of the flat plate portion 251, and the center button 230 is arranged in this hole 255. Moreover, the flat plate portion 251 has two holes 256 formed along the longitudinal direction of the flat plate portion 251, in a manner sandwiching the hole 255. The positions in which the holes 256 are formed correspond to the arrangement positions of connecting members 400A and 400B that will be described later. The holes 256 prevent interference between the connecting members 400A and 400B and the flat plate portion 251, and also facilitate attachment of the connecting members 400A and 400B.

Also, an example of the material used to form the urging member 250 may be material capable of imparting appropriate elasticity to the leaf spring 252, for example, various kinds of metal material such as aluminum, iron, stainless steel, copper, and titanium. Note that in the present embodiment, the parts of the urging member 250 are formed as a single unit, but the urging member according to the present disclosure does not have to be formed as a single unit. In such as case, the material used to form each part of the urging member may be set, as appropriate, according to the function of each part.

(Pusher Plate)

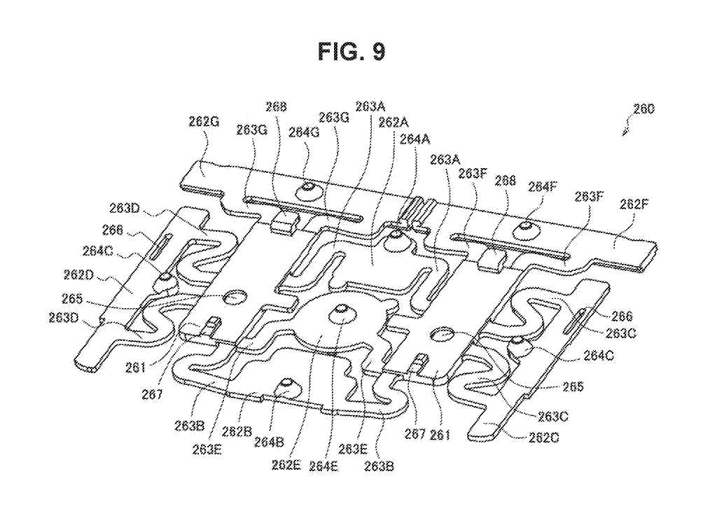

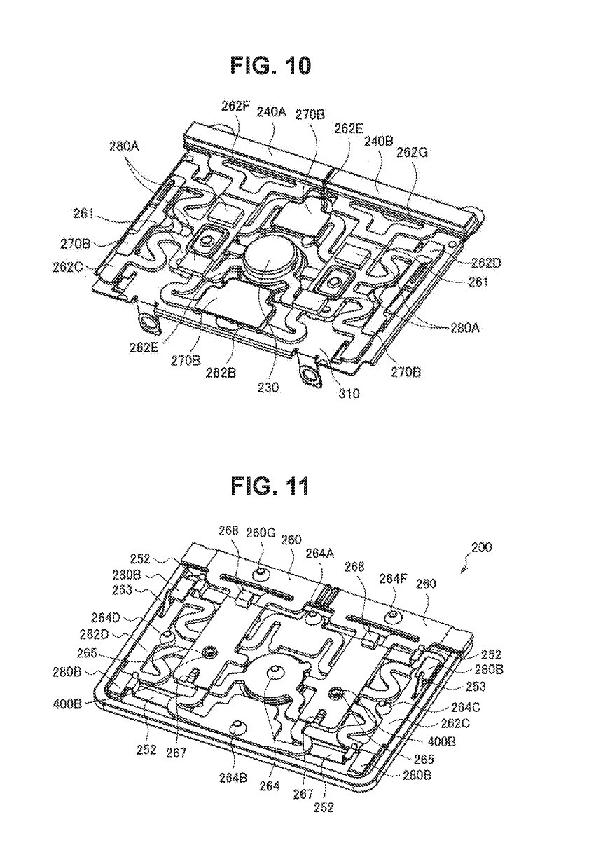

FIG. 9 is a perspective view of the pusher plate 260 illustrated in FIG. 5 as viewed from the switch substrate 1400 side, and FIG. 10 is a perspective view illustrating the pusher plate 260 illustrated in FIG. 5 in a mounted state.

As illustrated in FIG. 9, the pusher plate 260 is a plate that has pushers 264A to 264G that move in accordance with a pushing operation of the button panel portion 210. The pusher plate 260 has two connecting plates 261, movable plates 262A to 262G, hinges 263A to 263G, pushers 264A to 264G, two connecting holes 265, two holes 266, protrusions 267, and engaging protrusions 268.

The connecting plates 261 are plates for connecting the operating member 200 to the mounting member 300. One connecting hole 265 is provided in each of the connecting plates 261, and the protrusions 267 and the engaging protrusions 268 are arranged on the principal surface on the switch substrate 1400 side. The connecting plates 261 are connected to the mounting plate 310 of the mounting member 300 via these connecting holes 265, protrusions 267, and engaging protrusions 268. Note that the connecting holes 265, protrusions 267, and engaging protrusions 268 will be described in detail later in connection with the mounting plate 310.

The movable plates 262A to 262G are arranged corresponding to the positions to be pressed of the button panel portion 210. Moreover, the pushers 264A to 264G that are protrusions that protrude are arranged on the switch substrate side of the movable plates 262A to 262G, respectively. Therefore, the movable plates 262A to 262G are such that, in a case where the button panel portion 210 is pressed, the movable plates 262A to 262G and the pushers 264A to 264G that correspond to the pressed locations are pressed. Also, the tactile switch 1401 corresponding to the switch substrate 1400 is pressed via a rubber 330, described later, by the pushers 264A to 264G.

Also, the connecting plates 261 and the movable plates 262A to 262G are connected via the hinges 263A to 263G, respectively. The hinges 263A to 263G have suitable elasticity, and are able to bend away from and toward the mounting member 300 from the connecting plates 261. As a result, the movable plates 262A to 262G that are connected to the hinges 263A to 263G are able to move, with respect to the connecting plates 261, in a direction orthogonal to the principal surfaces of the connecting plates 261. The pushers 264A to 264G are also arranged on the movable plates 262A to 262G, and thus are also able to move, with respect to the connecting plates 261, in a direction orthogonal to the principal surfaces of the connecting plates 261. Moreover, the pushers 264A to 264G are connected via the hinges 263A to 263G and the connecting plates 261, and are thus able to move independently of each other.

On the other hand, the urging member 250 along with the center button 230 and the long buttons 240A and 240B are fixed, via the adhesive material 270A, to the principal surface on the button panel portion 210 side of the movable plates 262A to 262G, as illustrated in FIG. 10. Note that the urging member 250 is omitted in FIG. 10. More specifically, the urging member 250 is fixed on the movable plates 262A to 262D, the center button 230 is fixed on the movable plate 262E, and the long buttons 240A and 240B are fixed on the movable plates 262F and 262G, via the adhesive material 270A. Consequently, each button of the button panel portion 210 corresponds to a position of a pusher 264A to 264G.

Note that in fixing the urging member 250 to the movable plates 262A to 262D, a connecting member 400B that is a nut is disposed in the connecting hole 265. Also, in fixing the urging member 250 to the movable plates 262A to 262D, a cushion 280A may be arranged between the pusher plate 260 and the urging member 250. The cushion 280A suppresses excessive clicking noise by absorbing vibration in a case where a user pushes (clicks) the button panel portion 210. The arrangement position of the cushion 280A is not particularly limited, and in the present embodiment, the cushion 280A is disposed two on each connecting plate 261.

The holes 266 illustrated in FIG. 9 are formed in positions corresponding to the detachment controlling members 253 of the urging member 250, that is, in the movable plates 262C and 262D. The holes 266 are holes for preventing interference between the detachment controlling members 253 and the movable plates 262C and 262D, and allowing the detachment controlling members 253 to pass through to the mounting member 300 side.

FIG. 11 is a perspective view of the operating member 200 illustrated in FIG. 4 as viewed from the mounting member 300 side. In the present embodiment, the operating member 200 is formed by combining each of the members described above. The pushers 264A to 264G, the leaf springs 252, the connecting members 400B exposed through the connecting holes 265, the detachment controlling members 253, the protrusions 267, and the engaging protrusion 268 are exposed on the mounting member 300 side of the operating member 200. These exposed members are physically associated with each part of the mounting member 300.

Note that a cushion 280B may also be arranged on the mounting member 300 side of the operating member 200. Such an operating member 200 suppresses excessive clicking noise, similar to the cushion 280A. The arrangement position of the cushion 280B is not particularly limited, and in the present embodiment, the cushion 280B is disposed two on each movable plate 262D and 262C at both end portions in the longitudinal direction of the pusher plate 260.

(Other)

The operating member 200 does not have a protrusion, e.g., a rib (ridge), that serves as a fulcrum of mutual movement between a plurality of buttons (abutting portions in the present embodiment). Such a protrusion is provided to prevent a plurality of buttons from being pressed simultaneously. However, there are cases where such a protrusion may increase the inclination of the operating member, and thus cause the attitude of the operating member to become unstable. Therefore, the attitude of the operating member 200 in which such a protrusion is omitted is more stable. Note that the button unit in the present disclosure is not limited to this and can also have the protrusion described above. Even in such a case, the attitude of the operating member 200 is stable compared to the attitude of a conventional product, due to the urging member 250.

[2.2 Components of Mounting Member]

The mounting member 300 illustrated in FIG. 4 is for making the operating member 200 mount to the portable media player 1000. As illustrated in FIG. 5, the mounting member 300 has the mounting plate 310, the rubber 330, and adhesive material 350.

(Mounting Plate)

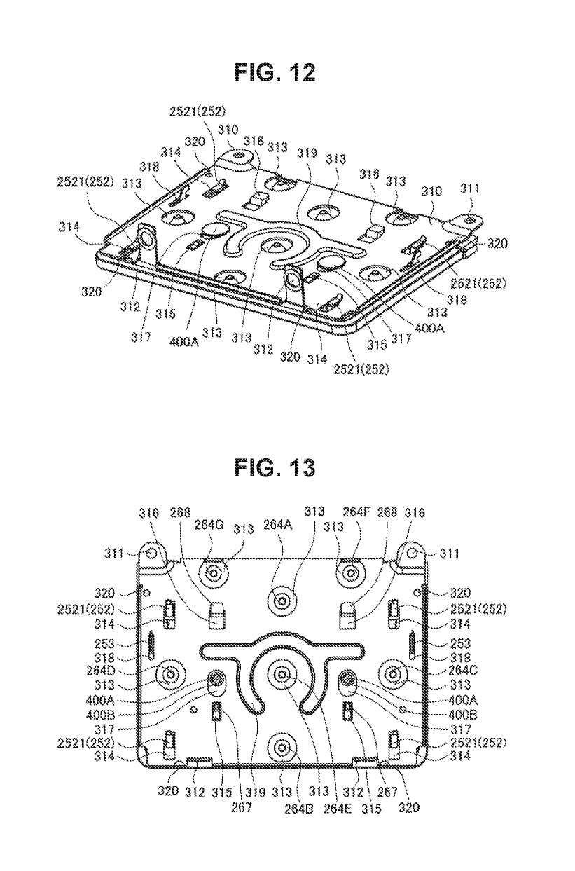

FIG. 12 is perspective view of the mounting plate 310 to which the operating member 200 illustrated in FIG. 5 is connected, and FIG. 13 is a plan view of the mounting plate 310 to which the operating member 200 illustrated in FIG. 5 is connected. The mounting plate 310 is a plate-like member configured to connect the operating member 200 to itself, and be fixed to the case 1100. Also, the side adjacent to the operating member 200 of the mounting plate 310 has a flat surface, and the operating member 200 is carried on the surface of the mounting plate 310 in a state in which the attitude of the operating member 200 is stable.

The mounting plate 310 connects, but does not fix, the operating member 200. Therefore, the operating member 200 is able to move along the surface of the mounting plate 310, i.e., in a direction orthogonal to the pressing direction in which a pressing operation is performed. Employing such a floating structure in which the mounting member 300 does not fix the operating member 200, and fixing the operating member 200 to the case 1100 by the mounting member 300 enables the gap between the button unit 100 and the case 1100 to be smaller.

Incidentally, with a conventional button, a flange portion is typically arranged surrounding the peripheral edge portion of the button. A conventional button is configured so as not to come off, by making the flange portion engage with the case of the electronic device. In such a case, an area for making the flange portion engage with the case must be prepared. Also, when a conventional button having such a flange portion is incorporated into the case, a case may occur where a portion of the button ends up contacting a wall surface of an opening of the case. This is typically due to dimensional accuracy and assembly accuracy of the parts. In such a case, the button may tend to wear, or rub such that the feel when pressing the button is uneven and not good, or the button may be pushed into the case and become stuck. Therefore, in order to prevent such problems, it is necessary to make the gap between the flange portion and the case relatively large.

However, with the button unit 100, the flange portion can be omitted due to employing the floating structure described above, and as a result, there is no need to ensure an area within which to arrange the flange portion. Therefore, the button unit 100 can be relatively large with respect to the case 1100. For example, a button unit 100 having a larger width than a case where a flange portion is provided, with respect to the width of the display-side surface of the case 1100, can be employed.

Also, even in a case where the operating member 200 abuts against a sidewall wall surface of the opening 1101, the operating member 200 is able to move in a direction orthogonal to the pressing direction in which a pressing operation is performed, so interference with the wall surface is prevented by moving, as appropriate, during a pressing operation. As a result, wear on the operating member 200 and the case 1100 is relatively reduced. Also, interference with the wall surface is prevented, so the feel of pressing during a pressing operation of the button unit 100 is uniform and good. Furthermore, the floating structure makes it possible to prevent such interference with the wall surface, and therefore enables the gap between the button unit 100 and the case 1100 to be made relatively small. As a result, the portable media player 1000 using the button unit 100 is able to make the existence of the button unit 100 less noticeable, so the external appearance is excellent.

The mounting plate 310 has fixing portions 311 and 312, pusher holes 313, engaging holes 314, position controlling holes 315 and 316, connecting holes 317, detachment controlling holes 318, a positioning portion 319, and tilt-restricting portions 320.

The fixing portions 311 and 312 are holes that are arranged protruding from edge portions of the mounting plate 310, respectively. The fixing portions 311 and 312 are able to fix the mounting plate 310 to the case 1100 by passing a screw through each hole and fixing the screw to the case 1100.

The pusher holes 313 are holes formed corresponding to the arrangement positions of the pushers 264A to 264G. By forming the pusher holes 313, interference between the mounting plate 310 and the pushers 264A to 264G can be prevented, and the pushers 264A to 264G can be inserted through the pusher holes 313.

The engaging holes 314 are formed in positions corresponding to the tip ends 2521 of the leaf springs 252, and are configured to be able to engage with the tip ends 2521. As a result of engaging with the engaging holes 314, the leaf springs 252 exert elastic force, which makes the urging of the urging member 250 with respect to the operating member 200.

The position controlling holes 315 and 316 are holes that are formed in positions corresponding to the protrusions 267 and the engaging protrusions 268, respectively. The protrusions 267 and engaging protrusions 268 are inserted into the position controlling holes 315 and 316. Here, the relationship between the position controlling holes 315 and 316, and the protrusions 267 and the engaging protrusions 268, will be described.

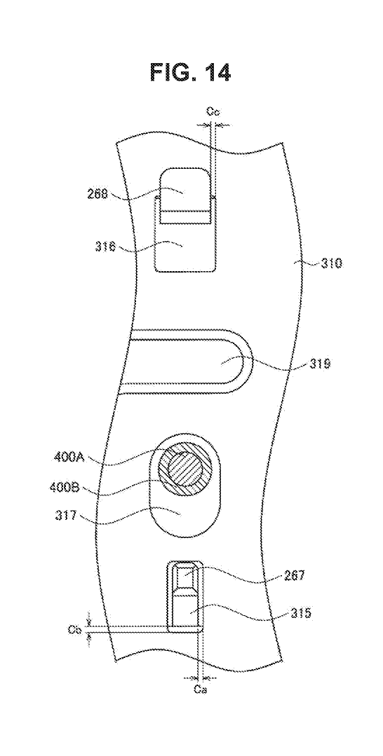

FIG. 14 is a partial enlarged view of the mounting plate 310 illustrated in FIG. 13. As illustrated in FIG. 14, the protrusion 267 is inserted into the position controlling hole 315. Also, the internal width and length of the position controlling hole 315 are formed larger than the width and length of the protrusion 267, by clearances Ca and Cb. On the other hand, the engaging protrusion 268 is inserted into the position controlling hole 316, and the tip end of the engaging protrusion 268 is bent so as to engage with the position controlling hole 316. Also, the internal width of the position controlling hole 316 is formed larger than the width of the engaging protrusion 268, by a clearance Cc. Note that the other holes formed in the mounting plate 310 are configured to have clearances of a distance equal to or greater than Ca to Cc, with respect to members to be inserted. Therefore, the operating member 200 is able to move the distance of the clearance along the surface direction of the mounting plate 310, with respect to the mounting member 300 that includes the mounting plate 310. That is, the movement range in the surface direction of the operating member 200 with respect to the mounting plate 310 is restricted by the movement range of the protrusions 267 and the engaging protrusions 268 within the position controlling holes 315 and 316. As a result, the operating member 200 is restricted from unintentionally moving much.

Note that the position controlling holes 315 and 316, the protrusions 267, and the engaging protrusions 268 are arranged in positions where abutting portions that will be described later are not arranged. Therefore, the urging member 250 can be arranged so as to be able to sufficiently urge the abutting portion, and the feel and stroke during a pressing operation of the button unit 100 will be uniform.

Also, the bent tip end of the engaging protrusion 268 is engaged with the edge portion of the position controlling hole 316, so movement of the operating member 200 in a direction orthogonal to the surface direction of the mounting plate 310 with respect to the mounting member 300 is also able to be restricted.

The connecting holes 317 illustrated in FIG. 12 and FIG. 13 are formed in positions corresponding to the connecting holes 265 in the pusher plate 260. Here, the connection of the operating member 200 and the mounting member 300 via the connecting holes 317 and the connecting holes 265 will be described. FIG. 15 is a partial enlarged sectional view illustrating the connection state of the mounting member 300 and the operating member 200 of the button unit 100 illustrated in FIG. 2.

As illustrated in FIG. 15, the connecting member 400A that is a bolt is inserted from the switch substrate 1400 side of the connecting hole 317, and the connecting member 400B that is a nut is arranged on the button panel portion 210 side of the connecting hole 265 in the pusher plate 260. Then, the pusher plate 260 and the mounting plate 310 are connected by the pusher plate 260 and the mounting plate 310 being sandwiched by the connecting member 400A and the connecting member 400B. As a result, the operating member 200 and the mounting member 300 are connected. Here, the distance (grip length) between the seating surfaces of the connecting member 400A and the connecting member 400B, in a state in which the connecting member 400A and the connecting member 400B are screwed together, is set larger, by the distance of the clearance Cd, than the total thickness of the portion where the pusher plate 260 and the mounting plate 310 are sandwiched by the connecting member 400A and the connecting member 400B. By setting such a clearance Cd, the mounting plate 310 and pusher plate 260 are connected but not fixed. As a result, the floating structure described above becomes possible.

The detachment controlling hole 318 illustrated in FIG. 12 and FIG. 13 is a hole formed in a position corresponding to the detachment controlling member 253 of the urging member 250. The detachment controlling hole 318 prevents the operating member 200 from detaching from the mounting member 300 by engaging with the detachment controlling member 253. Note that the detachment controlling hole 318 is formed relatively larger than the area near the tip end of the detachment controlling member 253. Therefore, the detachment controlling member 253 can be removed of the detachment controlling hole 318 by making the operating member 200 move in the surface direction of the mounting plate 310 with respect to the mounting member 300, so that the operating member 200 can be detached from the mounting member 300. However, in a case where the button unit 100 is mounted to the portable media player 1000, the operating member 200 is restricted from moving in this way so much that the operating member 200 is able to detach, by the wall surface of the case 1100. As a result, the operating member 200 of the button unit 100 that is mounted to the portable media player 1000 is prevented from unintentionally detaching.

The positioning portion 319 is a ridge provided near the center of the mounting plate 310 where the pusher holes 313 are not arranged. The positioning portion 319 is arranged in a depression of the rubber 330 that will be described later, and thus determines the position of the mounting plate 310 with respect to the rubber 330.

The tilt-restricting portions 320 are four protrusions provided on the edge portion of the mounting plate 310. The tilt-restricting portions 320 abut against the operating member 200 when the operating member 200 tilts, thereby restricting excessive tilt of the operating member 200.

(Rubber)

The rubber 330 illustrated in FIG. 5 is a sheet-like member for preventing fluid from entering into the case 1100 of the portable media player 1000. The rubber 330 is fixed to the mounting plate 310 via the adhesive material 350.

Also, as illustrated in FIG. 2, portions of the rubber 330 against which the pushers 264A to 264G abut form thin film portions 331 that are relatively thin and abut against the tactile switches 1401 of the switch substrate 1400. Therefore, each thin film portion 331 corresponding to the pushers 264A to 264G forms an abutting portion that abuts against and presses on a tactile switch 1401. For example, in FIG. 2, the pusher 264D and the thin film portion 331 form an abutting portion 500.

Also, as illustrated in FIG. 5, the rubber 330 has a depression corresponding to the positioning portion 319 of the mounting plate 310, in the surface contacting the mounting plate 310. Therefore, positioning related to the arrangement between the mounting plate 310 and the rubber 330 is possible. Also, the rubber 330 has holes formed corresponding to each of other members protruding from the mounting plate 310, thus preventing interference with these members.

Note that in the illustrated embodiment, the rubber 330 is described as being basically flat, but the shape may also be modified to improve the effect of preventing liquid from entering, for example. For example, a thick film portion that is thicker than the other portions may be provided at each edge of the end portion and each hole of the rubber 330.

Also, the mounting member 300 does not have a protrusion, e.g., a rib (ridge), that serves as a fulcrum of mutual movement between a plurality of buttons (abutting portions in the present embodiment), similar to the operating member 200.

[2.3 Components of Abutting Portion]

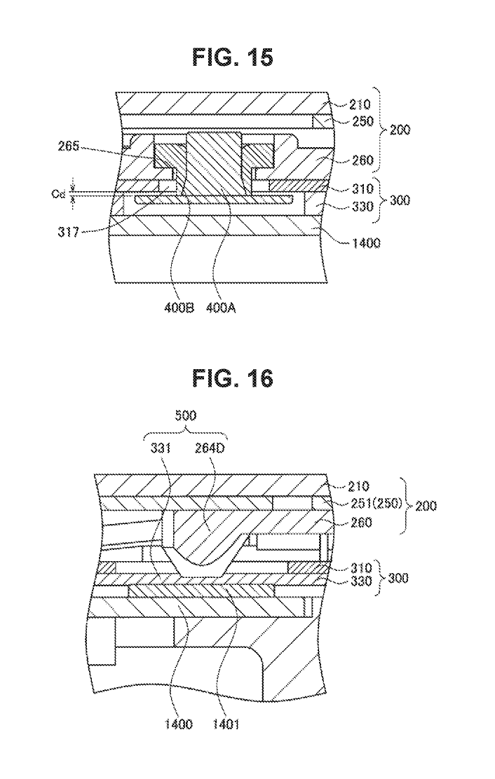

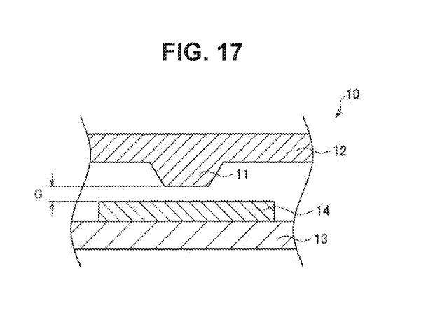

Heretofore, the components of each part of the button unit 100 have been described. Below, the abutting portions that include the rubber 330 and the pushers 264A to 264G will be described in more detail. Below, an abutting portion 500 that includes the pusher 264D and the thin film portion 331 will be representatively described with reference to FIG. 16, in comparison with the related art. FIG. 16 is a partial enlarged sectional view of the electronic device 1000 illustrated in FIG. 2, and FIG. 17 is a schematic sectional view of a switch device 10 according to related art.

As illustrated in FIG. 17, in the conventional switch device 10, typically there is a gap G between an operating panel 12 that includes a pusher 11, and a switch 14 that is carried on a substrate 13. This is a gap that is inevitable due to component accuracy, and assembly accuracy at the time of manufacture of the switch device 10. Such a gap generally tends to occur in buttons having a plurality of pushers for one button, e.g., in a directional key such as a four-direction button. Also, such a gap G can change according to the operating state and the carrying situation of the switch device 10. Therefore, if the gap G exists, the arrangement position of the operating panel 12 is not fixed, so the attitude of the operating panel 12 becomes unstable. Also, as the gap G changes, the stroke and feel when pressing a switch of the switch device 10 are less apt to be constant.

On the other hand, with the present embodiment, the abutting portion 500 includes the pusher 264D and the thin film portion 331 of the rubber 330, and abuts against the tactile switch 1401 of the switch substrate 1400, as illustrated in FIG. 16. Also, the abutting portion 500 is urged by the flat plate portion 251 of the urging member 250, by the pusher 264D that forms the abutting portion 500 being arranged on the operating member 200.

Incidentally, the abutting portion 500 is arranged to press the tactile switch 1401, while supporting the operating member 200 by abutting against the tactile switch 1401. Therefore, the abutting portion 500 that supports the operating member 200 in this way reliably abuts against the tactile switch 1401 as a result of the abutting portion 500 being urged. As a result, the attitude of the operating member 200 becomes more stable. Also, the stroke and feel at the time of a pressing operation of the button panel portion 210 become even more uniform.

Also, the abutting portion 500 extends from the operating member 200 toward the tactile switch 1401. Therefore, selective pressing of the tactile switch 1401 and support of the operating member 200 are possible simultaneously.

Note that as long as the force applied to the abutting portion 500 by the urging member 250 is smaller than the operating force of the tactile switch 1401, the force applied to the abutting portion 500 by the urging member 250 is not particularly limited, but can preferably be 10 to 50% of the operating force, and more preferably be 10 to 30% of the operating force. Consequently, the feel of pressing the tactile switch 1401 at the time of an operation can be made clearer, while the abutment of the abutting portion 500 against the tactile switch 1401 can be made more reliable. For example, in a case where the operating force of the tactile switch 1401 is 2.35 N, the force applied to the abutting portion 500 by the urging member 250 can be set to approximately 0.60 to 0.82 N.

Heretofore, the abutting portion 500 has been representatively described, but the same also applies to other abutting portions.

Incidentally, a plurality of abutting portions are arranged in the button unit 100 described above. In such a case, the feel and stroke among the plurality of buttons can also be made uniform by the plurality of abutting portions being similarly urged by the urging member 250.

In particular, four abutting portions including the pushers 264A to 264D and the thin film portion 331, together with the four-direction button 220, form a four-direction button. With a button having such a plurality of pressing positions, the attitude is typically difficult to stabilize due to large inclination of the surface panel. However, with the button unit 100, such a tendency is eliminated because the four-direction button 220 and the abutting portions are urged by the urging member 250. As a result, the feel and stroke of pressing at areas 221 to 224 for pressing the four-direction button 220 are uniform.

### 3. Other Components of Electronic Device

Next, the other components of the portable media player 1000 will be described. Note that descriptions of components not relevant to the present disclosure will be omitted according to the circumstances.

The case 1100 illustrated in FIG. 1 and FIG. 3 is a casing of the portable media player 1000, and carries or houses each component of the portable media player 1000. The lid 1200 is a lid for sealing an opening 1102 of the case 1100, while something such as an audio output terminal or a communication port for communicating with another electronic device is arranged in the lid 1200. The display 1300 displays an operation screen displayed according to an operation by the button unit 100, or a moving image or a still image instructed to be played by an operation.

Also, the switch substrate 1400 illustrated in FIG. 3 is an electronic substrate that includes a plurality of tactile switches 1401 as described above. The switch substrate 1400, together with the button unit 100, forms a switch system. Also, with the switch substrate 1400, the tactile switch 1401 operates in response to the tactile switch 1401 being pressed according to a pressing operation of the button unit 100. An input signal generated by operation of the tactile switch 1401 is sent to each component in the portable media player 1000, and is used to control the portable media player 1000. Note that the tactile switch 1401 is one example of a push switch.

Also, the switch substrate 1400 has a fixing hole 1402, and is fixed to the case by a screw 1403 as a fixture. Also, the preceding week of the contact surface with the casing of the switch substrate 1400 is adhered by adhesive material or an adhesive. Having the switch substrate 1400 be relatively firmly fixed to the case in this way results in the feel of pressing being more uniform and clear during a pressing operation of the button unit 100.

Also, the portable media player 1000 includes a processor, a main storage unit, and an auxiliary storage unit, and the like, which are used to control the portable media player 1000 itself, and for other purposes.

Also, the portable media player 1000 is configured to determine, in a case where two or more of the plurality of tactile switches 1401 are pressed simultaneously, which tactile switch 1401 input signal to give priority to. The button unit 100 does not have a protrusion that serves as a fulcrum of mutual movement between a plurality of abutting portions, so the tactile switches 1401 may be pressed simultaneously. However, having the configuration described above makes it easier for a user to press a button corresponding to the desired tactile switch 1401, and thus improves operability.

### 4. Summary

Heretofore, the portable media player 1000 as one example of an electronic device according to an embodiment of the present disclosure, and the button unit 100 provided with this portable media player 1000, have been described.

As described above, with the button unit 100, the arrangement position and inclination of the operating member 200 are prevented from becoming unstable, and thus the attitude of the operating member 200 is stabilized, by the operating member 200 being urged toward the tactile switches 1401 by the urging member 250. As a result, the feel and stroke in a pressing operation of the operating member 200 of the portable media player 1000 are able to be made uniform. Also, further, because the attitude of the operating member 200 is stabilized, the external appearance of the portable media player 1000 within which the button unit 100 is arranged is able to be excellent.

In particular, the button unit 100 includes the abutting portions that abut against the tactile switches 1401, the urged abutting portions are used to press the tactile switches 1401 and support the operating member 200. Therefore, the attitude of the operating member 200 of the portable media player 1000 is even further stabilized.

Also, the button unit 100 is configured such that the operating member 200 is able to move in a direction orthogonal to the pressing direction in which a pressing operation is performed, by having the operating member 200 be connected, but not fixed, to the mounting member 300. Therefore, the gap between the button unit 100 and the case 1100 can be made even smaller. As a result, the portable media player 1000 is able to make the existence of the button unit 100 less noticeable, so the external appearance is excellent.

### 5. Modified Examples

Heretofore, an embodiment of the present disclosure has been described. Below, several modified examples of the embodiment of the present disclosure are described. Note that each of the modified examples described below may be applied to the embodiment of the present disclosure individually, or may be applied to the embodiment of the present disclosure in combination. Also, each of the modified examples may be applied instead of the components described in the embodiment of the present disclosure, or may be applied in addition to the components described in the embodiment of the present disclosure.

First, in the embodiment describe above, the button panel portion 210 is described as including four button components, but the present technology is not limited to this example. For example, the button panel portion may include one button component. Also, the button panel portion can include, for example, 1 to 20 button components, more preferably, 1 to 10 button components, and even more preferably, 2 to 7 button components.

First, in the embodiment described above, a case in which one or four abutting portions is/are arranged for one button component of the button panel portion 210 is described, but the present technology is not limited to this example. For example, with the button panel portion, the abutting portion that is arranged can be modified, as appropriate, for one button component, according to its use and the number of corresponding switches in the switch substrate. Also, in a case where a plurality of abutting portions are arranged for one button component, i.e., in a case of a button unit that includes a directional key, the attitude of the operating member will be more stable. One such a modified example is a button unit in which two abutting portions are arranged for one button component, i.e., a button unit that includes a two-direction key, such as a +/− button for volume and an ON/OFF button of a power supply.

Also, in the embodiment describe above, the urging member 250 is described as being integrated with the operating member 200, but the present technology is not limited to this example. The urging member may also be formed as a separate member from the operating member.

Also, in the embodiment describe above, the urging member 250 is described as a member that performs urging by the elastic force of the leaf spring 252 as an elastic portion, but the present technology is not limited to this example. For example, the elastic portion of the urging member may also include an elastic body other than a leaf spring, such as a rubber member, a coil spring, a torsion bar, a disc spring, a flat spiral spring, a wave spring, or a volute spring, for example. Also, the urging member may include a plurality of different types of elastic bodies.

Also, in the embodiment describe above, the urging member 250 is described as a member that includes the four leaf springs 252 as elastic bodies, but the present technology is not limited to this example. For example, the urging member can include one or more elastic body. Note that in a case where the urging member includes a plurality of elastic bodies, the urging toward the operating member by the urging member is uniform, so the attitude of the pressing member is even more easily stabilized.

Also, in the embodiment describe above, the urging member 250 is described as a member that urges the entire operating member 200, but the present technology is not limited to this example. For example, the urging member may be a member that partially urges the operating member.

Also, in the embodiment described above, the abutting portions are described as including the pushers 264A to 264G and the thin film portion 331 of the rubber 330, but the present technology is not limited to this example. For example, the abutting portions may include only the pushers 264A to 264G.

Also, in the embodiment described above, the mounting member 300 is described as including the rubber 330, but the present technology is not limited to this example. The rubber can be omitted as necessary.

Also, in the embodiment described above, the protrusions 267 and the engaging protrusions 268 are described as being arranged on the operating member 200, and the position controlling holes 315 and 316 are described as being arranged on the mounting member 300, but the present technology is not limited to this example. For example, a protrusion and a position controlling hole may also be arranged on either the operating member or the mounting member. Also, in a case where there are a plurality of protrusions, the protrusions can also be arranged on both the operating member and the mounting member. In this case, position controlling holes are arranged in both the operating member and the mounting member, corresponding to the positions of the protrusions. Also, instead of a protrusion, an arbitrary member that is able to be inserted into the position controlling hole can be used. Examples of such a member include, for example, a pin that passes through the position controlling hole, and a screw, e.g., a nut and bolt.

Also, in the embodiment describe above, the button unit 100 is described as being mounted to the portable media player 1000, but the present technology is not limited to this example. For example, the button unit according to the present disclosure can be applied not only to various types of switches such as a switch that is an electrical switch and a physical changeover switch, but to any member as long as the member is a member to be pressed. Also, the button unit may be a button unit for an electronic device, which is used for an electronic device.

Also, in the embodiment describe above, the portable media player 1000 is described as one example of an electronic device, but the present technology is not limited to this example. For example, the electronic device can be a mobile electronic device such as a mobile phone, a smartphone, a PHS, a PDA, a tablet PC, a laptop computer, a video camera, or an IC recorder, or another electronic device such as a desktop computer, a display unit, a television receiver, a radio receiver, or a video recorder. In particular, with a mobile electronic device, it is often necessary to make the case relatively small because an emphasis is typically placed on portability. In such a case, the effect of the technology according to the present disclosure described above is more significant displayed.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A button unit including:

an operating member that presses a member to be pressed, in response to being press operated; and

an urging member that urges the operating member against the member to be pressed.

(2)

The button unit according to (1), in which

an abutting portion that abuts against the member to be pressed is arranged on the operating member.

(3)

The button unit according to (1) or (2), in which

a plurality of abutting portions that abut against the member to be pressed are arranged on the operating member.

(4)

The button unit according to (3), in which

four of the abutting portions are arranged so as to form a four-direction button, on the operating member.

(5)

The button unit according to any one of (2) to (5), in which

the abutting portion extends toward the member to be pressed.

(6)

The button unit according to any one of (1) to (5), in which

the urging member has an elastic portion.

(7)

The button unit according to any one of (2) to (5), in which

the urging member has a plurality of elastic portions, and

each of the elastic portions is arranged in a position where the abutting portion is not arranged.

(8)

The button unit according to any one of (1) to (7), in which

the operating member is configured to be able to move in a direction orthogonal to a pressing direction in response to a pressing operation.

(9)

The button unit according to (8), further including:

a mounting member capable of mounting the operating member to a device having the member to be pressed,

in which the operating member is configured to be able to move in a direction along a surface of the mounting member adjacent to the operating member.

(10)

The button unit according to (9), in which

the mounting member has a flat surface formed on a side adjacent to the operating member.

(11)

The button unit according to (9) or (10), further including:

one or more holes provided in one of the mounting member or the operating member; and

one or more protrusions provided on the other of the mounting member or the operating member and arranged protruding into the holes,

in which a movement range of the operating member with respect to a surface direction of the mounting member is restricted by a movement range of the protrusions in the holes.

(12)

The button unit according to (11), further including:

a plurality of the protrusions,

in which the operating member has an abutting portion that abuts against the member to be pressed, and

each of the plurality of protrusions is arranged in a position where the abutting portion is not arranged.

(13)

The button unit according to any one of (1) to (12), in which

the operating member has an abutting portion that abuts against the member to be pressed, and

the urging member has a flat plate portion for pressing the abutting portion toward the member to be pressed.

(14)

The button unit according to any one of (1) to (13), in which

the operating member has a plurality of abutting portions that abut against the member to be pressed, and

the operating member does not have a protrusion that serves as a fulcrum of mutual movement between the plurality of abutting portions.

(15)

The button unit according to any one of (1) to (14), further including:

a mounting member capable of mounting the operating member to a device having the member to be pressed,

in which the operating member has a detachment controlling member that controls detachment from the mounting member, by engaging with the mounting member.

(16)

The button unit according to any one of (1) to (15), in which

an operating surface of the operating member includes hard material.

(17)

The button unit according to any one of (1) to (16), in which

the member to be pressed is a push switch.

(18)

The button unit according to any one of (1) to (16), which is a button unit for an electronic device.

(19)

An electronic device including:

a button unit having an operating member that presses a push switch in response to being press operated, and an urging member that urges the operating member against the push switch; and

an electronic circuit board that includes the push switch.

(20)

The electronic device according to (19), in which

the electronic circuit board includes a plurality of the push switches, and

the electronic device is configured to determine, in a case where two or more of the plurality of push switches are pressed simultaneously, which push switch electrical signal switching to give priority to.

(21)

A button unit including:

an operating member that presses a member to be pressed, in response to being press operated, in which

the operating member is configured to be able to move in a direction orthogonal to a pressing direction in response to a pressing operation.

(22)

An electronic device comprising:

a button unit that includes an operating member that presses a push switch in response to being press operated; and

an electronic circuit board that includes the push switch,

wherein the operating member is configured to be able to move in a direction orthogonal to a push direction in response to a pressing operation.

### REFERENCE SIGNS LIST

10 switch device
11 pusher
12 operating panel
13 substrate
14 switch
100 button unit
200 operating member
210 button panel portion
220 four-direction button
221 up direction pressing area
222 down direction pressing area
223 left direction pressing area
224 right direction pressing area
225 through-hole
230 center button
240A, 240B long buttons
250 urging member
251 flat plate portion
252 leaf spring
2521 tip end
253 detachment controlling member
254 conducting member
255, 256 holes
260 pusher plate
261 connecting plate
262A, 262B, 262C, 262D, 262E, 262F, 262G movable plates
263A, 263B, 263C, 263D, 263E, 263F, 263G hinges
264A, 264B, 264C, 264D, 264E, 264F, 264G pushers
265 connecting hole
266 hole
267 protrusion
268 engaging protrusion
270A, 270B adhesive material
280A, 280B cushions
300 mounting member
310 mounting plate
311, 312 fixing portions
313 pusher hole
314 engaging hole
315, 316 position controlling holes
317 connecting hole
318 detachment controlling hole
319 positioning portion
320 tilt-restricting portion
330 rubber
331 thin film portion
350 adhesive material
400A, 400B connecting members
500 abutting portion
1000 portable media player (electronic device)
1100 case
1101, 1102 openings
1200 lid
1300 display
1400 switch substrate
1401 tactile switch
1402 fixing hole
1403 screw

1. A button unit comprising:
an operating member that presses a member to be pressed, in response to being press operated; and
an urging member that urges the operating member against the member to be pressed.

2. The button unit according to claim 1, wherein
an abutting portion that abuts against the member to be pressed is arranged on the operating member.

3. The button unit according to claim 1, wherein
a plurality of abutting portions that abut against the member to be pressed are arranged on the operating member.

4. The button unit according to claim 2, wherein
four of the abutting portions are arranged so as to form a four-direction button, on the operating member.

5. The button unit according to claim 2, wherein
the abutting portion extends toward the member to be pressed.

6. The button unit according to claim 1, wherein
the urging member has an elastic portion.

7. The button unit according to claim 2, wherein
the urging member has a plurality of elastic portions, and
each of the elastic portions is arranged in a position where the abutting portion is not arranged.

8. The button unit according to claim 1, wherein
the operating member is configured to be able to move in a direction orthogonal to a pressing direction in response to a pressing operation.

9. The button unit according to claim 8, further comprising:
a mounting member capable of mounting the operating member to a device having the member to be pressed,
wherein the operating member is configured to be able to move in a direction along a surface of the mounting member adjacent to the operating member.

10. The button unit according to claim 9, wherein
the mounting member has a flat surface formed on a side adjacent to the operating member.

11. The button unit according to claim 9, further comprising:
one or more holes provided in one of the mounting member or the operating member; and
one or more protrusions provided on the other of the mounting member or the operating member and arranged protruding into the holes,
wherein a movement range of the operating member with respect to a surface direction of the mounting member is restricted by a movement range of the protrusions in the holes.

12. The button unit according to claim 11, further comprising:
a plurality of the protrusions,
wherein the operating member has an abutting portion that abuts against the member to be pressed, and
each of the plurality of protrusions is arranged in a position where the abutting portion is not arranged.

13. The button unit according to claim 1, wherein
the operating member has an abutting portion that abuts against the member to be pressed, and
the urging member has a flat plate portion for pressing the abutting portion toward the member to be pressed.

14. The button unit according to claim 1, wherein
the operating member has a plurality of abutting portions that abut against the member to be pressed, and
the operating member does not have a protrusion that serves as a fulcrum of mutual movement between the plurality of abutting portions.

15. The button unit according to claim 1, further comprising:
a mounting member capable of mounting the operating member to a device having the member to be pressed,
wherein the operating member has a detachment controlling member that controls detachment from the mounting member, by engaging with the mounting member.

16. The button unit according to claim 1, wherein
an operating surface of the operating member includes hard material.

17. The button unit according to claim 1, wherein
the member to be pressed is a push switch.

18. The button unit according to claim 1, which is a button unit for an electronic device.

19. An electronic device comprising:
a button unit having an operating member that presses a push switch in response to being press operated, and an urging member that urges the operating member against the push switch; and
an electronic circuit board that includes the push switch.

20. The electronic device according to claim 19, wherein
the electronic circuit board includes a plurality of the push switches, and
the electronic device is configured to determine, in a case where two or more of the plurality of push switches are pressed simultaneously, which push switch input signal to give priority to.
